(19) United States
(12) Patent Application Publication
(10) Pub. No.: US 2003/0005794 A1
(43) Pub. Date: Jan. 9, 2003

(54) MANUALLY OPERATED TOOL BIT STRUCTURE HAVING GEAR SHIFTING DEVICE

(76) Inventor: Rou-Fon Shih, Taichung (TW)

Correspondence Address: Hart, Baxley, Daniels & Holton, Fifth Floor, 59 John Street, New York, NY, 10038, US

(21) Appl. No.: 09/898,128

(22) Filed: Jul. 5, 2001

(51) Int. Cl. B25B 17/00

(52) U.S. Cl. 81/57.31

(57) ABSTRACT

A manually operated tool bit structure includes a handgrip, an operation member, and a gear shifting device fitted with the handgrip and having an actuating portion whereby a fitting ring of the operation member is fitted with the actuating portion of the gear shifting device so that the gear shifting device is rigidly connected with the handgrip while the handgrip and the gear shifting device will not detach from each other due to the effect of an operational force. In addition, the gear shifting device includes a plurality of locking lugs which are detachably received in the locking cavities defined the handgrip so that the gear shifting device can also be rotated with rotation of the handgrip.

### BACKGROUND OF THE INVENTION

1. Field of the Invention

The present invention relates to a manually operated tool bit structure, and more particularly to a manually operated tool bit structure having a gear shifting device.

2. Description of the Related Art

A conventional manually operated tool bit structure having a gear shifting device in accordance with the prior art shown in FIG. 1 comprises a body, a gear set 11 mounted in the body 10 which is rotated in concert with a power input fitting head 12 and a power output fitting head 13, and a rotary handle 14 for rotating the power input fitting head 12. The gear set 11 can be adapted to perform a speed change action so as to change the output torsion and the rotational speed of the manually operated tool bit structure. However, the power output fitting head 13 is directly fitted on the body 10, and the power input fitting head 12 is directly fitted on the rotary handle 14 so that they easily detach from each other during operation due to the effect of the force exerted by the user. In addition, the rotary handle 14 and the body 10 can co-operate to change the output torsion and the rotational speed of the manually operated tool bit structure. However, the rotary handle 14 and the body 10 cannot cooperate to perform an “ordinary operation mode” (that is, when the rotary handle 14 is rotated through one circle, the body 10 can also be rotated through one circle).

### SUMMARY OF THE INVENTION

The present invention has arisen to mitigate and/or obviate the disadvantage of the conventional manually operated tool bit structure having a gear shifting device.

In accordance with one aspect of the present invention, there is provided a manually operated tool bit structure having a gear shifting device comprising:

a handgrip defining therein a receiving space and a slide space connecting to the receiving space, the receiving space having one end having a periphery provided with a plurality of locking flanges, the slide space having an inner wall having two opposite sides each defining a guide track, the slide space having one end defining a fitting opening, the fitting opening defining a plurality of locking cavities and having a lower portion defining an annular groove, an operation opening defined in a wall of the handgrip and connecting to the annular groove, a catch wall provided in the operation opening;

an operation member movably mounted in the operation opening of the handgrip and provided with a fitting ring movably mounted in the annular groove, the fitting ring having a first end provided with a first fitting portion and a second end provided with a second fitting portion, a pressing spring mounted in the operation opening of the handgrip and having a first end pressing one side of the operation member and a second end pressing the catch wall of the operation opening;

a locking member mounted in the slide space of the handgrip and provided with two opposite slide ears each slidably mounted in the guide track of the slide space, the locking member having a first end provided with an insert portion and a second end provided with an abutting portion;

a push member secured in the receiving space of the handgrip and including a push rod, and a push disk mounted on one end of the push rod and rested on the locking flanges of the receiving space;

a push spring mounted in the receiving space of the handgrip and having a first end pressing the abutting portion of the locking member and a second end pressing the push disk of the push member; and

a gear shifting device mounted on the handgrip and including a housing having two ends and spaced from the fitting opening of the handgrip, a driving gear set mounted in the housing, two actuating portions each mounted on a respective end of the housing and each having a mediate portion defining an annular retaining groove, each of the two actuating portions having a first end provided with a plurality of locking lugs detachably received in the locking cavities of the fitting opening of the handgrip and a second end provided with an actuating head rotated in concert with the driving gear set and detachably mounted on the insert portion of the locking member.

The primary objective of the present invention is to provide a manually operated tool bit structure having a gear shifting device, wherein, when the gear shifting device is fitted with the handgrip, the fitting ring of the operation member is fitted with the actuating portion of the gear shifting device so that the gear shifting device is rigidly connected with the handgrip while the handgrip and the gear shifting device will not detach from each other due to the effect of an operational force.

The secondary objective of the present invention is to provide a manually operated tool bit structure having a gear shifting device, wherein, the locking lugs are secured in the locking cavities so that the gear shifting device can also be rotated with rotation of the handgrip, thereby greatly increasing the versatility of the manually operated tool bit structure.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional manually operated tool bit structure having a gear shifting device in accordance with the prior art;

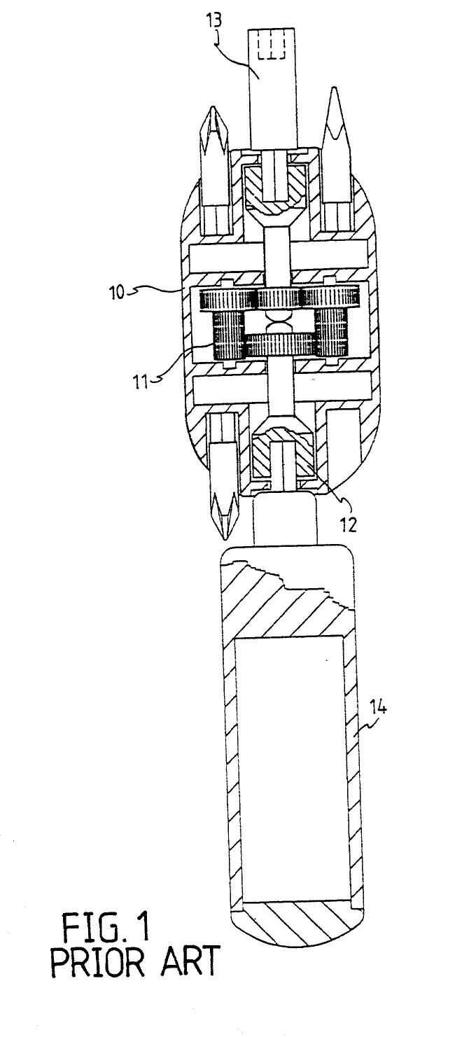

FIG. 2 is an exploded view of a manually operated tool bit structure having a gear shifting device in accordance with the present invention;

FIG. 3 is a front plan cross-sectional assembly view of the manually operated tool bit structure as shown in FIG. 2;

FIG. 4 is an operational view of the manually operated tool bit structure as shown in FIG. 3; and

FIG. 5 is an operational view of the manually operated tool bit structure as shown in FIG. 4.

### DETAILED DESCRIPTION OF THE INVENTION

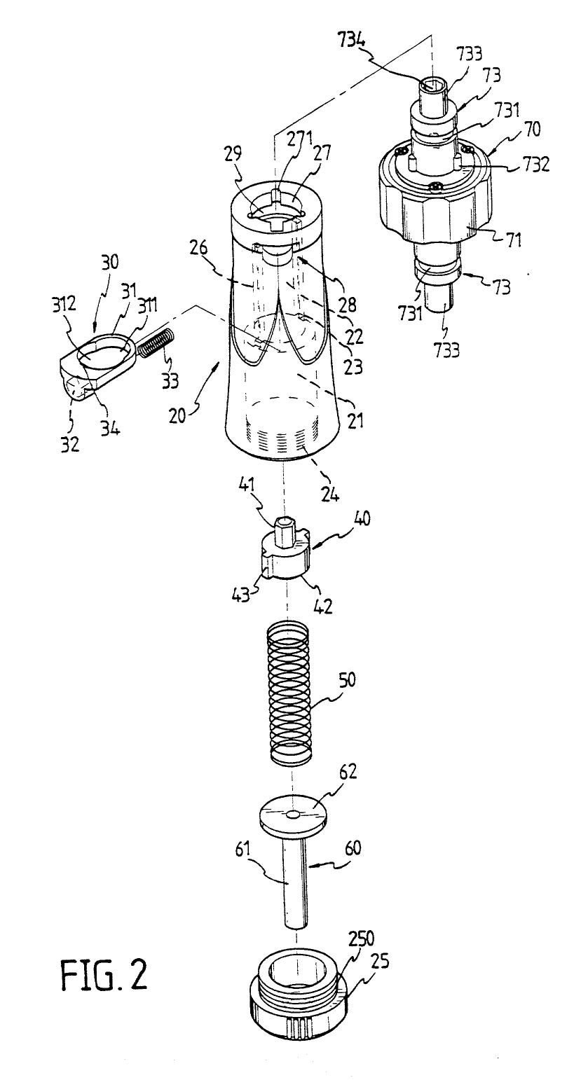

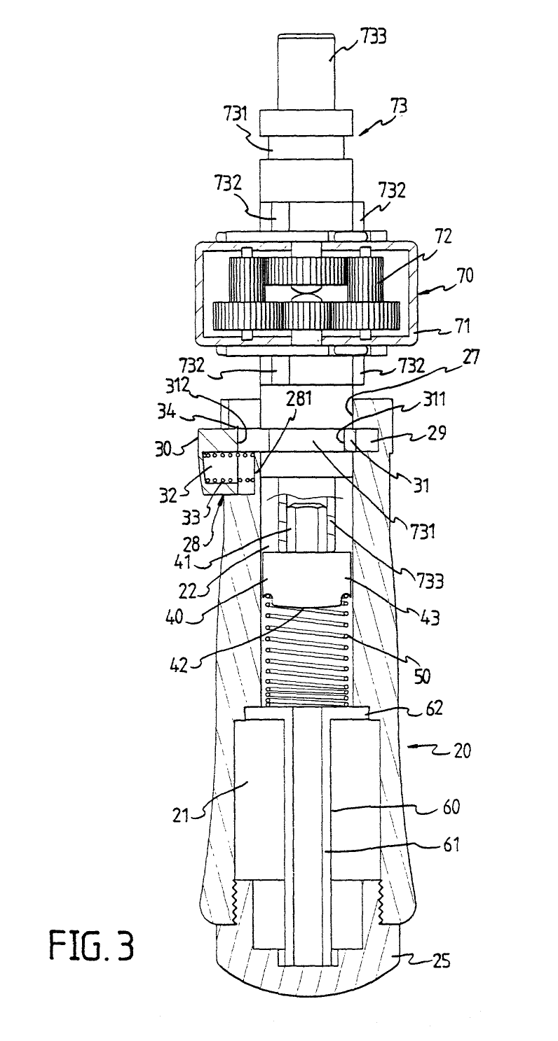

Referring to the drawings and initially to FIGS. 2 and 3, a manually operated tool bit structure having a gear shifting device in accordance with the present invention comprises a handgrip 20, an operation member 30, a locking member 40, a push member 60, a push spring 50, and a gear shifting device 70.

The handgrip 20 defines therein a receiving space 21 and a slide space 22 connecting to the receiving space 21 which has one end having a periphery provided with two locking flanges 23. The slide space 22 has an inner wall having two opposite sides each defining a guide track 26 and has one end defining a fitting opening 27 which defines a plurality of locking cavities 271 and has a lower portion defining an annular groove 29. An operation opening 28 is defined in a side wall of the handgrip 20 and connects to the annular groove 29, and a catch wall 281 is provided in the operation opening 28.

The operation member 30 is movably mounted in the operation opening 28 of the handgrip 20 and is provided with a fitting ring 31 movably mounted in the annular groove 29. The fitting ring 31 has a first end provided with a first fitting portion 311 and a second end provided with a second fitting portion 12. A pressing spring 33 is mounted in the operation opening 28 of the handgrip 20 and has a first end pressing one side of the operation member 30 and a second end pressing the catch wall 281 of the operation opening 28. The operation member 30 has a receiving recess 32 defined in one side thereof for receiving the pressing spring 33. The operation member 30 has one end face provided with a limit flange 34 detachably rested on the side wall of the operation opening 28 for preventing the operation member 30 from detaching from the operation opening 28.

The locking member 40 is mounted in the slide space 22 of the handgrip 20 and is provided with two opposite slide ears 43 each slidably mounted in the guide track 26 of the slide space 22 whereby the locking member 40 can slide in the slide space 22, and cannot be rotated in the slide space 22. The locking member 40 has a first end provided with a hexagonal insert portion 41 and a second end provided with an abutting portion 42.

The push member 60 is secured in the receiving space 21 of the handgrip 20 and includes a push rod 61, and a push disk 61 mounted on the top end of the push rod 61 and rested on the locking flanges 23 of the receiving space 21.

The push spring 50 is mounted in the receiving space 21 of the handgrip 20 and has a first end pressing the abutting portion 42 of the locking member 40 and a second end pressing the push disk 62 of the push member 60.

The manually operated tool bit structure also comprises a rotary cap 25 secured on the bottom of the receiving space 21 of the handgrip 20 and rested on the bottom end of the push rod 61 of the push member 60 for securing the push rod 61 in the receiving space 21. The receiving space 21 of the handgrip 20 is provided with an inner thread 24, and the rotary cap 25 is provided with an outer thread 250 screwed in the inner thread 24 of the receiving space 21 of the handgrip 20.

The gear shifting device 70 is located above the handgrip 20 and includes a housing 71 having two ends and spaced from the fitting opening 27 of the handgrip 20, a driving gear set 72 mounted in the housing 71, two actuating portions 73 each mounted on a respective end of the housing 71 and each having a mediate portion defining an annular retaining groove 731.

Each of the two actuating portions 73 has a first end provided with a plurality of locking lugs 732 detachably received in the locking cavities 271 of the fitting opening 27 of the handgrip 20 and a second end provided with an actuating head 733 which can be rotated in concert with the driving gear set 72 and can be detachably mounted on the insert portion 41 of the locking member 40. The actuating head 733 of the actuating portion 73 of the gear shifting device 70 defines a hexagonal recess 734 for securing the hexagonal insert portion 41 of the locking member 40.

By such an arrangement, the first fitting portion 311 of the fitting ring 31 of the operation member 30 is initially located between the actuating portion 73 of the gear shifting device 70 and the locking member 40 so that the actuating portion 73 cannot pass through the first fitting portion 311 to touch the locking member 40.

The operation member 30 is then pressed inward in the operation opening 28 whereby the second fitting portion 312 of the fitting ring 31 of the operation member 30 is initially located between the actuating portion 73 of the gear shifting device 70 and the locking member 40 so that the actuating portion 73 can pass through the second fitting portion 312 to touch the locking member 40 whereby the hexagonal insert portion 41 of the locking member 40 is fitted into the hexagonal recess 734 of the actuating head 733 of the actuating portion 73 of the gear shifting device 70.

The operation member 30 is then released so that the first fitting portion 311 of the fitting ring 31 of the operation member 30 is received in the annular retaining groove 731 of the actuating portion 73 of the gear shifting device 70, thereby retaining the actuating portion 73 of the gear shifting device 70.

The handgrip 20 co-operates with the gear shifting device 70 to perform a “speed change operation”, wherein, the driving gear set 72 is used for changing the speed or torsion, and to perform an “ordinary operation”, wherein, the driving gear set 72 is not operated.

When the manually operated tool bit structure in accordance with the present invention is disposed in the “speed change operation” mode, as shown in FIG. 3, the first fitting portion 311 of the fitting ring 31 of the operation member 30 is secured in the annular retaining groove 731 of the actuating portion 73 of the gear shifting device 70, while the hexagonal insert portion 41 of the locking member 40 is secured in the hexagonal recess 734 of the actuating head 733 of the actuating portion 73 of the gear shifting device 70.

In operation, the user's one hand holds the housing 71 of the gear shifting device 70 with the other hand holding and rotating the handgrip 20 which then rotates the locking member 40 which rotates the insert portion 41 which rotates the actuating head 733 which drives the driving gear set 72 to perform a speed change action or a torsion transmission, thereby achieving the “speed change operation” mode.

In such a manner, the first fitting portion 311 of the fitting ring 31 of the operation member 30 is secured in the annular retaining groove 731 of the actuating portion 73 of the gear shifting device 70, so that the gear shifting device 70 is rigidly connected with the handgrip 20 whereby the handgrip 20 and the gear shifting device 70 will not detach from each other due to the effect of the operational force exerted by the user.

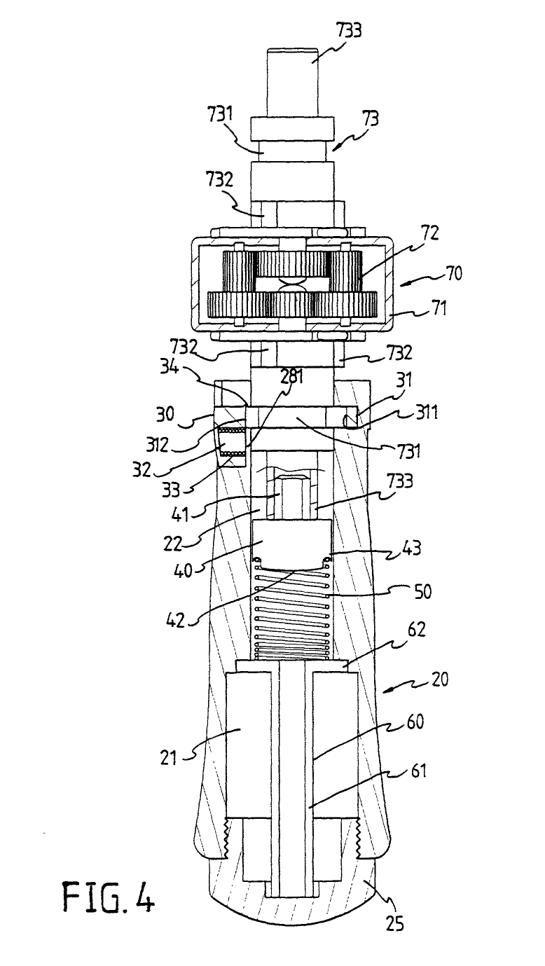

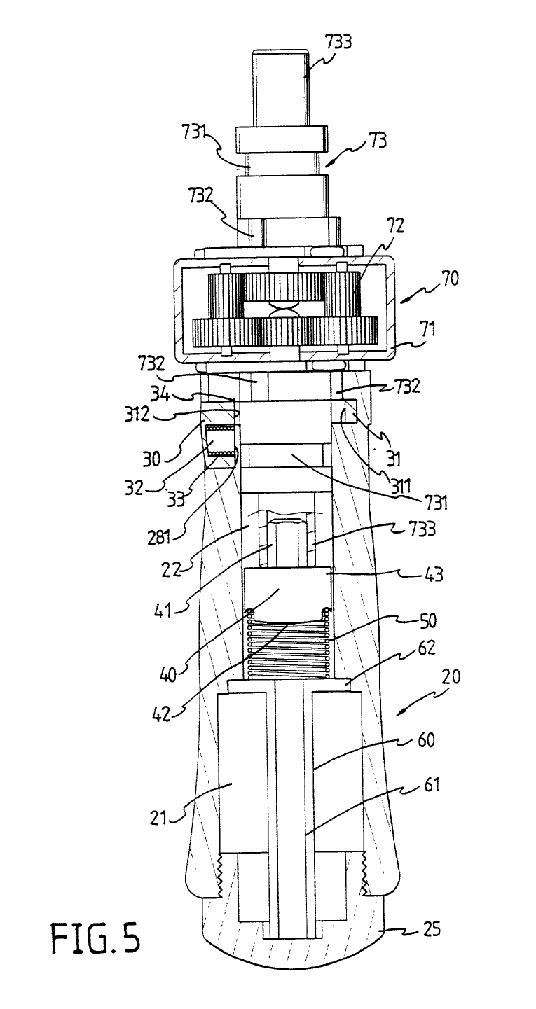

When the manually operated tool bit structure in accordance with the present invention is disposed in the “ordinary operation” mode, the operation member 30 is pressed to detach the first fitting portion 311 of the fitting ring 31 of the operation member 30 from the annular retaining groove 731 of the actuating portion 73 of the gear shifting device 70, while the second fitting portion 312 of the fitting ring 31 of the operation member 30 is secured in the annular retaining groove 731 of the actuating portion 73 of the gear shifting device 70 as shown in FIG. 4. The gear shifting device 70 is then pressed downward so that the locking lugs 732 are respectively secured in the locking cavities 271 whereby the gear shifting device 70 is locked with the handgrip 20 as shown in FIG. 5.

In such a manner, when the handgrip 20 is rotated by the user, the gear shifting device 70 is rotated in concert with the handgrip 20 whereby the rotation of the handgrip 20 will rotate the whole gear shifting device 70, not only the actuating head 733, thereby achieving the “ordinary operation” mode. That is, when the handgrip 20 is rotated through one circle, the gear shifting device 70 is also rotated through one circle.

It should be clear to those skilled in the art that further embodiments may be made without departing from the scope of the present invention.

What is claimed is:

1. A manually operated tool bit structure having a gear shifting device comprising:
a handgrip (20) defining therein a receiving space (21) and a slide space (22) connecting to said receiving space (21), said receiving space (21) having one end having a periphery provided with a plurality of locking flanges (23), said slide space (22) having an inner wall having two opposite sides each defining a guide track (26), said slide space (22) having one end defining a fitting opening (27), said fitting opening (27) defining a plurality of locking cavities (271) and having a lower portion defining an annular groove (29), an operation opening (28) defined in a wall of said handgrip (20) and connecting to said annular groove (29), a catch wall (281) provided in said operation opening (28);
an operation member (30) movably mounted in said operation opening (28) of said handgrip (20) and provided with a fitting ring (31) movably mounted in said annular groove (29), said fitting ring (31) having a first end provided with a first fitting portion (311) and a second end provided 18 with a second fitting portion (312), a pressing spring (33) mounted in said operation opening (28) of said handgrip (20) and having a first end pressing one side of said operation member (30) and a second end pressing said catch wall (281) of said operation opening (28);
a locking member (40) mounted in said slide space (22) of said handgrip (20) and provided with two opposite slide ears (43) each slidably mounted in said guide track (26) of said slide space (22), said locking member (40) having a first end provided with an insert portion (41) and a second end provided with an abutting portion (42);
a push member (60) secured in said receiving space (21) of said handgrip (20) and including a push rod (61), and a push disk (62) mounted on one end of said push rod (61) and rested on said locking flanges (23) of said receiving space (21);
a push spring (50) mounted in said receiving space (21) of said handgrip (20) and having a first end pressing said abutting portion (42) of said locking member (40) and a second end pressing said push disk (62) of said push member (60); and
a gear shifting device (70) mounted on said handgrip (20) and including a housing (71) having two ends and spaced from said fitting opening (27) of said handgrip (20), a driving gear set (72) mounted in said housing (71), two actuating portions (73) each mounted on a respective end of said housing (71) and each having a mediate portion defining an annular retaining groove (731), each of said two actuating portions (73) having a first end provided with a plurality of locking lugs (732) detachably received in said locking cavities (271) of said fitting opening (27) of said handgrip (20) and a second end provided with an actuating head (733) rotated in concert with said driving gear set (72) and detachably mounted on said insert portion (41) of said locking member (40).

2. The manually operated tool bit structure in accordance with claim 1, wherein said operation member (30) has a receiving recess (32) defined in one side thereof for receiving said pressing spring (33).

3. The manually operated tool bit structure in accordance with claim 1, wherein said operation member (30) has one end face provided with a limit flange (34) detachably rested on a wall of said operation opening (28) for preventing said operation member (30) from detaching from said operation opening (28).

4. The manually operated tool bit structure in accordance with claim 1, further comprising a rotary cap (25) secured on a bottom of said receiving space (21) of said handgrip (20) and rested on a bottom end of said push rod (61) of said push member (60) for securing said push rod (61) in said receiving space (21).

5. The manually operated tool bit structure in accordance with claim 4, wherein said receiving space (21) of said handgrip (20) is provided with an inner thread (24), and said rotary cap (25) is provided with an outer thread (250) screwed in said inner thread (24) of said receiving space (21) of said handgrip (20).

6. The manually operated tool bit structure in accordance with claim 1, wherein said actuating head (733) of said actuating portion (73) of said gear shifting device (70) defines a hexagonal recess (734), and said insert portion (41) of said locking member (40) has a mating hexagonal shape to be secured in said hexagonal recess (734).
